(19) United States
(12) Patent Application Publication
(10) Pub. No.: US 2002/0180165 A1
(43) Pub. Date: Dec. 5, 2002

(54) Heat-shrinkable chuck

(76) Inventors: Thomas Retzbach, Bonnigheim (DE); Ralph Kersten, Heilbronn (DE)

Correspondence Address: Joseph W Berenato III, Liniak Berenato Longacre & White, 6550 Rock Spring Drive Ste 240, Bethesda, MD, 20817, US

(21) Appl. No.: 10/148,259

(22) PCT Filed: Sep. 12, 2001
(86) PCT No.: PCT/EP01/10519

(30) Foreign Application Priority Data
Sep. 29, 2000 (DE) 100 48 772.6

(51) Int. Cl. B23B 31/117

(52) U.S. Cl. 279/102; 29/447; 403/273

(57) ABSTRACT

The invention describes a heat-shrink chuck for clamping tools by means of a shrink fit, having a chuck body (1), capable of being secured on the working spindle of a machine tool, in which a central receptacle (2) is configured for the shaft (3) of a tool that is to be clamped, which is characterized in that the central receptacle (2) is configured in noncircular fashion and has along its circumference multiple clamping regions, arranged spaced apart from one another and lying on a common diameter, by way of which the shaft (3) is clamped; and damping regions (5) of greater diameter are configured between the clamping regions (4).

The present invention concerns a clamping chuck for clamping tools by means of a shrink fit, having a chuck body, capable of being secured on the working spindle of a machine tool, in which a central receptacle is configured for the shaft of a tool that is to be clamped.

Clamping chucks of this kind are known in a variety of embodiments, and serve to secure a tool shaft, for example a drill shaft or milling cutter shaft, in the working spindle of a corresponding machine tool. They are used in particular in order to clamp small tools.

Conventional clamping chucks for clamping tools by means of a shrink fit usually comprise a clamp body made of metal, which can be mounted on the working spindle of the respective machine tool and has a central receptacle for the shaft of the tool that is to be clamped. The diameter of the receptacle is determined in such a way that it is somewhat smaller than the diameter of the tool shaft. In order to chuck the tool, the clamp body is heated at least in the region of the receptacle until the latter has thermally expanded sufficiently that the tool shaft can be inserted into it. Upon subsequent cooling, the receptacle shrinks again so that the tool shaft is secured in the receptacle by means of a press fit or shrink fit (DE 39 25 641 C2).

So-called heat-shrink chucks of this kind have proven entirely successful in practical use. Because of the hard clamping of the shaft, however, flexing effects can occur during use and can ultimately result in breakage of the fully carbide shaft of the tool.

It is therefore the object of the invention to configure a clamping chuck of the kind cited initially in such a way that flexing effects in the tool shaft during operation are at least largely prevented.

According to the present invention, this object is achieved in that the central receptacle is configured in noncircular fashion and has along its circumference multiple clamping regions, arranged spaced apart from one another and lying on a common diameter, by way of which the shaft is clamped; and damping regions of greater diameter are configured between the clamping regions. According to the present invention, a shaft is thus secured only in the clamping regions, while the damping regions located therebetween have a greater diameter so they merely rest loosely against the shaft or indeed so that a gap is formed between the receptacle wall and the shaft. This configuration makes the clamping of the tool shaft “softer,” with the consequence that the “propeller shaft effects” occurring in the existing art because of the hard clamping of the shaft, which can lead to tool breakage, are ruled out or largely prevented.

According to an embodiment of the invention, provision is made for the inner circumferential contour of the chuck body, forming the receptacle, to comprise multiple (in particular, three) shallowly cambered circumferential segments forming the clamping regions and a corresponding number of transitional arcs lying therebetween and forming the damping regions. In particular, the circumferential contour forming the receptacle can be of polygonal or polygon-like configuration with curved segments. These embodiments have the advantage that the circumferential contour can be manufactured easily.

As regards further advantageous embodiments of the invention, the reader is referred to the dependent claims and to the description below of an exemplary embodiment with reference to the appended drawings, in which:

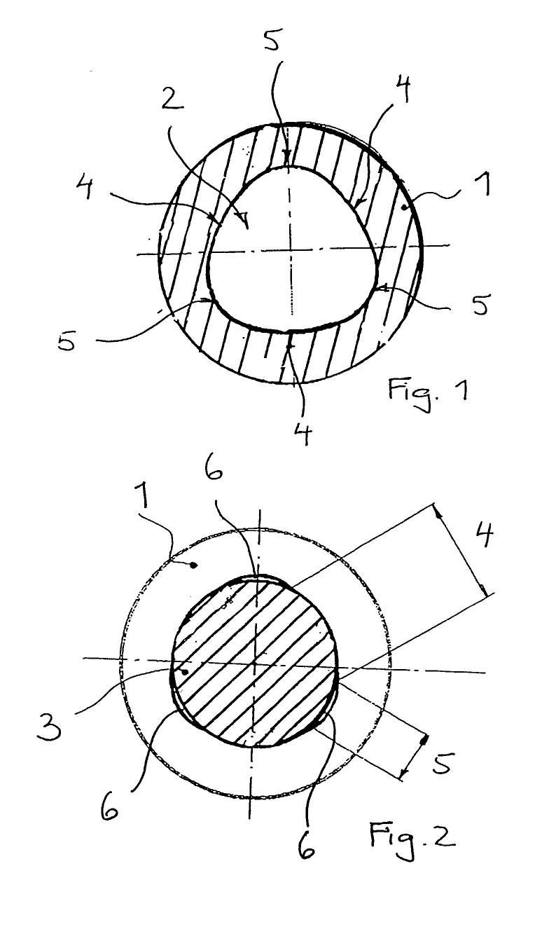

FIG. 1 shows, in cross section, a heat-shrink chuck according to the present invention in the unclamped state; and

FIG. 2 shows the heat-shrink chuck of FIG. 1 with a tool shaft clamped therein.

FIGS. 1 and 2 depict an embodiment according to the present invention of a heat shrink chuck for clamping tools by means of a shrink fit. The clamping chuck comprises a chuck body 1 made of a dimensionally stable material (in this case, steel) which has at its one end region a central receptacle 2 into which, after heating of receptacle 2 and its expansion associated therewith, a cylindrical shaft 3 of a tool, for example a drill or milling cutter, can be inserted; and which at its other end region, in a manner known per se, can be chucked into a rotationally driven working spindle of a machine tool.

According to the present invention, receptacle 2 is of noncircular configuration; in the exemplary embodiment depicted, it possesses a polygonal shape with three shallowly cambered circumferential segments 4 and three transitional arcs 5 located therebetween. The shallowly cambered circumferential segments 4 form clamping regions with which a shaft 3 inserted into receptacle 2 is secured with the application of pressure, i.e. which lie on a diameter of the receptacle that is somewhat smaller than the shaft diameter, while transitional arcs 5 located therebetween possess a greater diameter and form damping regions in which the receptacle wall merely rests loosely against shaft 3, or is spaced away from shaft 3 forming gaps 6. The consequence of these damping regions 5 is that chuck body 1 is softer in the region of the clamping point, so that vibrations occurring during operation are damped. Breakages of tool shaft 3, which occur in conventional chucks because of the hard clamping and the propeller shaft effects associated therewith, can thereby be prevented.

1. A heat-shrink chuck for clamping tools by means of a shrink fit, having a chuck body (1), capable of being secured on the working spindle of a machine tool, in which a central receptacle (2) is configured for the shaft (3) of a tool that is to be clamped,
wherein the central receptacle (2) is configured in noncircular fashion and has along its circumference multiple clamping regions, arranged spaced apart from one another and lying on a common diameter, by way of which the shaft (3) is clamped; and damping regions (5) of greater diameter are configured between the clamping regions (4).

2. The heat-shrink chuck as defined in claim 1, wherein the inner circumferential contour forming the receptacle (2) comprises three shallowly cambered circumferential segments forming the clamping regions (4) and three transitional arcs lying therebetween and forming the damping regions (5).

3. The heat-shrink chuck as defined in claim 1 or 2, wherein the circumferential contour forming the receptacle (2) is of polygonal or polygon-like configuration with curved segments.

4. The heat-shrink chuck as defined in one of the foregoing claims, wherein the receptacle (2) possesses in the damping regions (5) a diameter that is greater than the diameter of a shaft (3) that is to be clamped, so that gaps (6) are formed between the shaft (3) and the receptacle wall.
